(19) United States
(12) Patent Application Publication
(10) Pub. No.: US 2008/0215592 A1
(43) Pub. Date: Sep. 4, 2008

(54) INFORMATION PROCESSING APPARATUS AND IDENTIFICATION INFORMATION REGISTRATION METHOD

(75) Inventor: Daisuke Morita, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/954,920

(22) Filed: Dec. 12, 2007

(30) Foreign Application Priority Data
Feb. 1, 2007 (JP) 2007-23368

(51) Int. Cl. G06F 17/30

(52) U.S. Cl. 707/10; 707/E17.001

(57) ABSTRACT

An information processing apparatus and method determining whether a site corresponding to identification information of a request exists on a network, and registering identification information in a storage device based on a result of the determination.

### CROSS-REFERENCE TO RELATED APPLICATIONS

This application is related to and claims the benefit of priority from Japanese patent application No. 2007-23368, filed on Feb. 1, 2007, in the Japan Patent Office the entire contents of which are incorporated herein by reference.

### BACKGROUND

1. Field of the Invention

The present invention relates to information processing including registering identification information for identifying a location of an information providing site on a network in response to a registration request from a user, and more particularly, to an information processing apparatus and an identification information registration method which minimizes data communication traffic in the case of registering a uniform resource locator (URL) as a bookmark.

2. Description of the Related Art

In recent years, the Internet environment has improved and devices such as a personal computer and a mobile terminal device (hereinafter simply referred to as “terminal device”) capable of connecting to the Internet have become widely used. A user uses the above described terminal device to access various web sites on the Internet, and obtains various information (for example, information such as texts, images, sounds, videos, etc.).

Moreover, the terminal device may be provided with a function of registering a URL (Uniform Resource Locator) of a web site which the user has liked (a bookmark function), and the user can use the bookmark function to efficiently access the web site. It should be noted that, if the user registers the URL, the user has had to register the URL after temporarily inputting the URL in the terminal device and checking a web page corresponding to the above described URL.

However, in the above described environment, even if the user uses the bookmark function to simply register the user's favorite URL (in the case of only registering the URL and not browsing the web site), it is necessary to temporarily input the URL in the terminal device and display the web site corresponding to the URL on the terminal device, which requires unnecessary data communication.

Furthermore, in recent years, a terminal device having a function of simultaneously registering multiple URLs has also become widely used, and data communication traffic generated at the time of the URL registration has further increased. Thereby, problems associated with unnecessarily establishing data communication(s) have become serious. Particularly, in portable device(s) such as a mobile terminal device, a fee may be added depending on the amount of packets exchanged. Therefore, it is desirable to minimize the data communication traffic.

The present technique is directed to solving the above described and other problems, by providing an information processing apparatus and an identification information registration method enabled to minimize the data communication traffic including in the case of registering the URL as a bookmark.

### SUMMARY

The disclosed information processing apparatus includes a determination unit which determines whether a site corresponding to identification information obtained exists on a network a registration unit which registers identification information in a storage device based on a result of the determination by determination unit when the registration request from the user is accepted.

According to the disclosed method and apparatus, if the identification information for identifying a location of the information providing site on the network has been obtained and the registration request from the user has been accepted, it is determined whether the site corresponding to the identification information exists on the network, and the identification information is registered in the storage device based on the determination result. Therefore, a burden on the user can be reduced and also data communication traffic at the time of registering the identification information can be minimized.

Moreover, according to the disclosed method and apparatus, when multiple pieces of the identification information have been obtained and a registration request has been accepted, it is determined whether a site corresponding to each piece of the identification information exists on the network, and the identification information corresponding to the site which exists on the network is registered in the storage device based on the determination result. Therefore, the multiple pieces of the identification information can be efficiently registered while reducing the data communication traffic.

Additional aspects and/or advantages will be set forth in part in the description which follows and, in part, will be apparent from the description, or may be learned by practice of the invention.

Moreover, according to the present technique, a history of a determination result of whether the site corresponding to the identification information exists is stored as history information, and it is determined whether the site exists on the network by using the history information. Therefore, unnecessary data communication can be eliminated.

Moreover, according to the present technique, if the identification information has been obtained and the registration request from the user has been accepted, it is determined whether the identification information is included in the history information, and if the identification information is not included in the history information, the site corresponding to the identification information is accessed and it is determined whether the site exists on the network. Therefore, unnecessary data communication can be eliminated.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a functional block diagram illustrating a configuration of an information processing apparatus;

FIG. 2 is a diagram illustrating a data structure of a registered URL file;

FIG. 3 is a diagram illustrating a data structure of a URL history table;

FIG. 4 is a diagram illustrating a data structure of a favorite's registration table;

FIG. 5 is a diagram illustrating an output device displaying a query result;

FIG. 6 is a diagram illustrating an output device displaying searched information;

FIG. 7 is a flowchart illustrating a processing procedure of the information processing apparatus;

FIG. 8 is a flowchart illustrating a processing procedure of the information processing apparatus;

FIG. 9 is a diagram illustrating a URL input dialog;

FIG. 10 is a diagram illustrating a browser screen displayed on an output device; and

FIG. 11 is a diagram illustrating a hardware configuration of a computer configuring the information processing apparatus shown in FIG. 1.

### DETAILED DESCRIPTION OF THE PREFERRED EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

First, a brief summary and characteristics of the information processing apparatus according to this embodiment will be described. The disclosed information processing apparatus and method relates to information processing which registers a URL (Uniform Resource Locator) for identifying a location of an information providing site on a network as a bookmark or the like, in response to a registration request from a user. Accordingly, when a URL has been obtained and a registration request from the user has been accepted, the disclosed apparatus and method determines whether a site corresponding to the URL exists on the network, and based on a result of the determination, the URL is registered as a bookmark.

In this way, since the information processing apparatus and method includes determining whether or not the URL for which the registration request from the user has been accepted exists on the network, and registers the above described URL as the bookmark based on the determination result, the user is not required to check whether or not the corresponding site exists in the case of registering the URL, which can reduce a burden on the user.

Moreover, in the case of registering the URL as the bookmark, the disclosed information processing apparatus does not require displaying the site corresponding to the URL on a display device (a display or the like), which minimizes data communication traffic with respect to an apparatus providing the above described site.

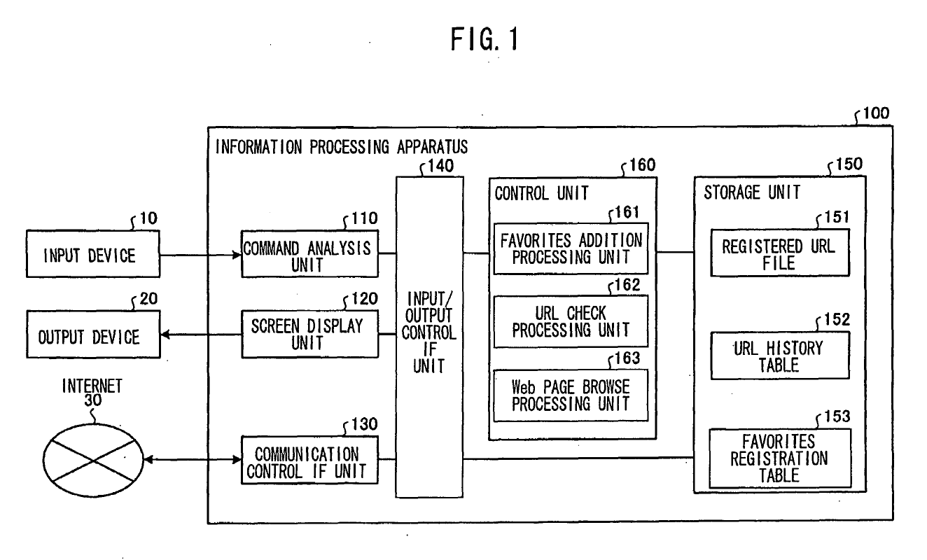

Next, a configuration of the information processing apparatus according to this embodiment will be described. FIG. 1 is a functional block diagram showing an exemplary configuration of the information processing. As shown in FIG. 1, the information processing apparatus 100 is connected with an input device 10 and an output device 20, and is configured to include a command analysis unit 110, a screen display unit 120, a communication control IF unit 130, an input/output control IF unit 140, a storage unit 150 and a control unit 160.

The input device 10 enables various information to be input and may be configured with a keyboard, a mouse, a microphone, etc. In one embodiment, a user operates the input device 10 and inputs the URL in the information processing apparatus 100 to register the URL in the information processing apparatus 100.

The output device 20 enables various information to be output and may be configured with a monitor (or a display or a touch panel), a speaker, etc. Moreover, the output device 20 realizes a pointing device function in cooperation with, for example, the mouse of the above described input device 10.

The command analysis unit 110 is a processing unit which obtains various information from the input device 10 and analyzes the obtained information to determine a process (command) to be executed. For example, if the command analysis unit 110 determines that the information obtained from the input device 10 includes a URL and a registration request pertaining to the URL, the command analysis unit 110 outputs the obtained information and a result of the determination to the control unit 160.

The screen display unit 120 is a processing unit which obtains various information from the control unit 160 and outputs the obtained information to the output device 20. The communication control IF unit 130 may utilize an apparatus (not shown) providing various web sites on the Internet 30 and a predetermined communication protocol to execute data communication.

The input/output control IF unit 140 is a processing unit which controls input and output of data with respect to the command analysis unit 110, the screen display unit 120, the communication control IF unit 130, the storage unit 150 and the control unit 160.

The storage unit 150 is a storage unit which stores data and programs required for processing various information including those utilized by the control unit 160. The storage unit 150 includes a registered URL file 151, a URL history table 152 and a favorite's registration table 153.

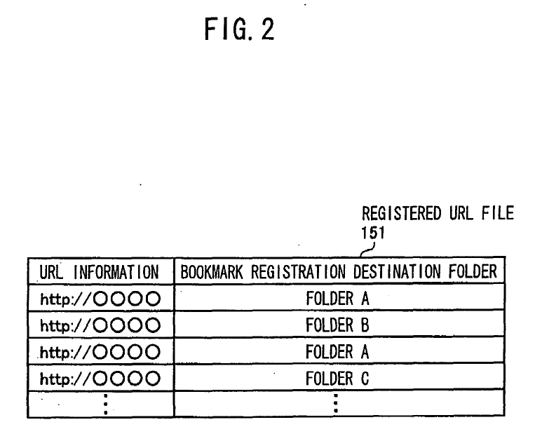

The registered URL file 151 is a file which stores information of the URL to be registered. FIG. 2 is a diagram showing an example of a data structure of the registered URL file 151. As shown in FIG. 2, the registered URL file 151 is configured with URL information and information of bookmark registration destination folders. Here, the bookmark registration destination folder is information identifying a folder in which a URL is registered. For example, as shown in FIG. 2, the information shows that the URL at the first row is registered in a folder A. This registered URL file 151 is generated by the user operating the input device 10.

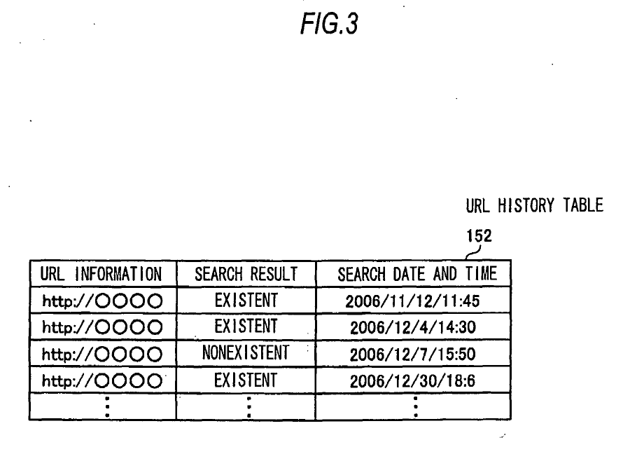

The URL history table 152 (FIG. 3) is a table which stores a past history of whether or not the web site corresponding to the URL exists on the network. An example of a data structure of the URL history table 152 is shown in FIG. 3. As shown in FIG. 3, the URL history table 152 includes URL information, search results, and search dates and times, etc. While the URL history table 152 is described using specific examples, the disclosed table is not limited thereto and may include various types of information pertaining to a URL and/or other identifying information of a web site including but not limited to access and request data directed to the web site.

Here, the search result is information showing whether or not the URL searched by the control unit 160 in the past has existed on the network. For example, in FIG. 3, the information shows that the URL at the first row exists on the network.

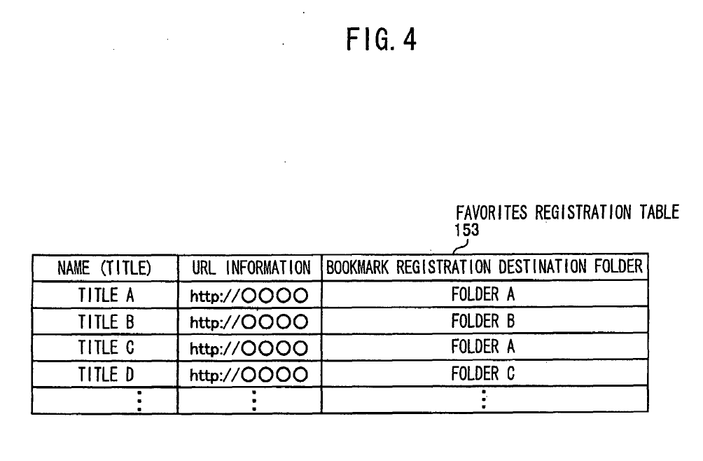

The favorite's registration table 153 (FIG. 4) is a table which stores information to be registered as the bookmark. An example of a data structure of the favorite's registration table 153 is shown in FIG. 4. As shown in FIG. 4, the favorite's registration table 153 includes names (titles), URL information and bookmark registration destination folders.

The name identifies the title of a site corresponding to the URL, and the bookmark registration destination folder identifies the folder in which the URL has been registered. At the first row of FIG. 4, the information shows that a URL “http://****” having a name “Title A” has been registered in “Folder A”.

Returning to the description of FIG. 1, the control unit 160 may include an internal memory for storing programs prescribing various processing procedures or control data and executes various processes in accordance therewith. As shown in FIG. 1, the control unit 160 may include a favorite's addition processing unit 161, a URL check processing unit 162 and a Web page browse processing unit 163.

The favorite's addition processing unit 161 is a processing unit which registers the URL in the favorite's registration table 153. When the favorites addition processing unit 161 receives information of a URL to be registered, the favorites addition processing unit 161 queries whether a site corresponding to the URL exists on the network, by communicating with the URL check processing unit 162, and based on a result of the query, registers the URL in the favorites registration table 153. The URL to be registered may be received or obtained from the input device 10 or the registered URL file 151 stored in the storage unit 150.

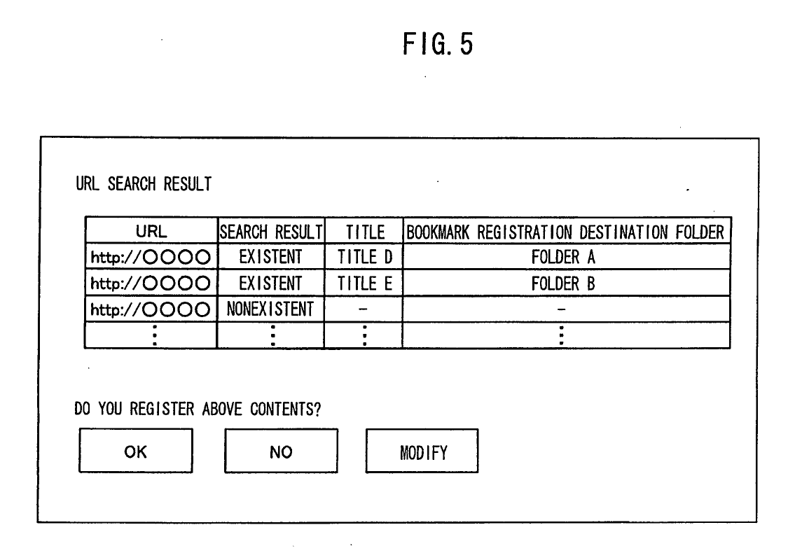

The favorites addition processing unit 161 obtains the query result from the URL check processing unit 162 (a search result at the URL check processing unit 162) and outputs information on the query result to the output device 20. FIG. 5 is a diagram illustrating a screen provided via the output device 20 displaying the query result. As shown in FIG. 5, the information of whether or not the URL exists on the network is displayed on an output screen.

Then, if the user selects “OK” via the input device 10, the favorite's addition processing unit 161 registers the information of the URL which exists on the network, in the favorite's registration table 153. When “NO” is selected, the favorites addition processing unit 161 does not register the URL. Moreover, when “Modify” is selected, the favorites addition processing unit 161 reflects the information inputted from the input device 10 (for example, modifies the title) and subsequently registers the URL in the favorites registration table 153.

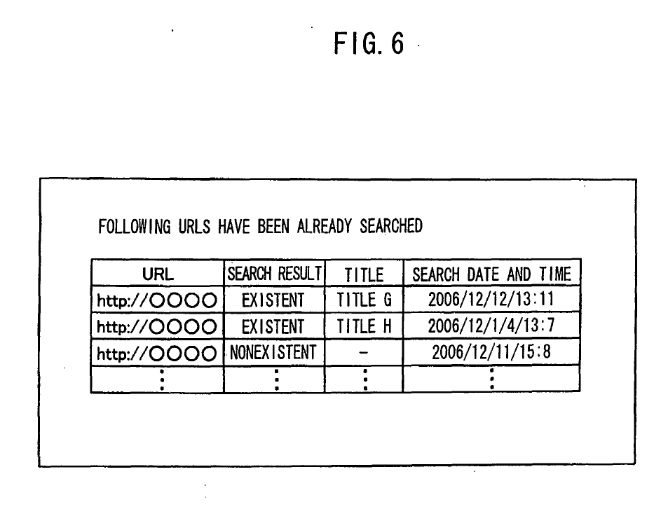

It should be noted that, if the favorites addition processing unit 161 has obtained information which has been searched, from the URL check processing unit 162, the favorites addition processing unit 161 outputs the searched information to the output device 20. FIG. 6 is a diagram illustrating a screen provided via the output device 20 displaying the searched information. As shown in FIG. 6, this screen includes URLs for which the user has previously issued the registration request, the information on whether or not the URL has existed, etc. Among the URLs to be registered, the favorite's addition processing unit 161 may be configured to not register the URLs included in the searched information, into the favorite's registration table 153.

The URL check processing unit 162 is a processing unit which, if the URL has been obtained from the favorite's addition processing unit 161, determines whether or not the obtained URL exists on the network. The URL check processing unit 162 determines whether the URL obtained from the favorite's addition processing unit 161 exists in the URL history table 152. Then, if the URL exists in the URL history table 152, the URL check processing unit 162 generates the searched information including the search result, the title and the search date and time of the above described URL, and outputs the searched information which has been generated, to the favorites addition processing unit 161.

Subsequently, the URL check processing unit 162 determines whether or not the URL which is not included in the URL history table 152 exists on the network, and outputs the determination result (query result) to the favorite's addition processing unit 161. Determination of whether or not a URL exists on the network may be achieved using various techniques. For example, if an access request has been outputted to the site corresponding to the URL and subsequently a response has been returned from the site, the URL check processing unit 162 may determine that the site corresponding to the URL exists.

It is assumed that this determination result includes the information on the URL, the title, the search result and the search date and time. It should be noted that the URL check processing unit 162 stores the history of the URL of which the determination has been performed, in the URL history table 152. The URL check processing unit 162 associates the determination result of whether or not the URL exists with the URL and registers them in the URL history table 152.

The Web page browse processing unit 163 is a processing unit for realizing a browser function, and in this embodiment, mainly, if the URL has been inputted from the input device 10, the Web page browse processing unit 163 outputs the site corresponding to the above described URL to the output device 20. Moreover, also if the URL which has been registered in the favorite's registration table 153 as the bookmark has been selected, the Web page browse processing unit 163 outputs the site corresponding to the selected URL to the output device 20.

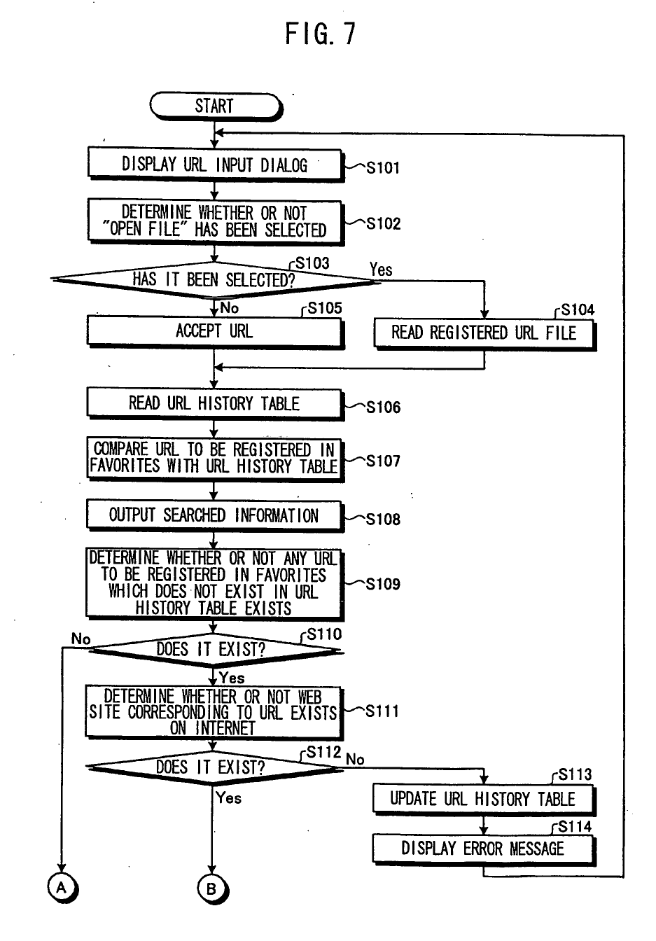

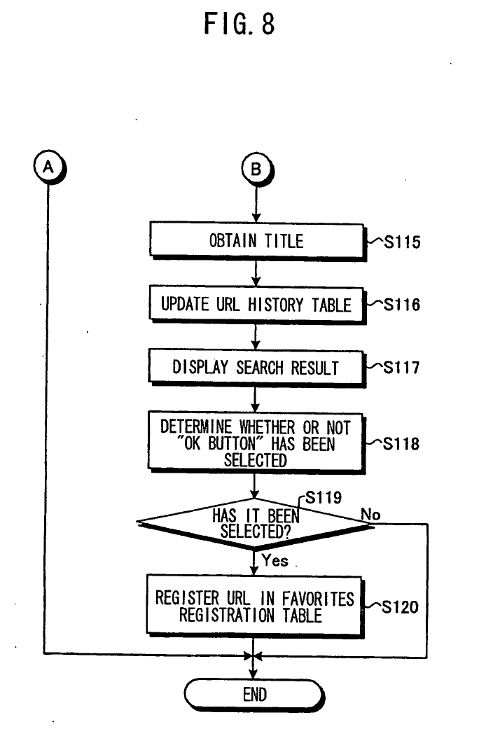

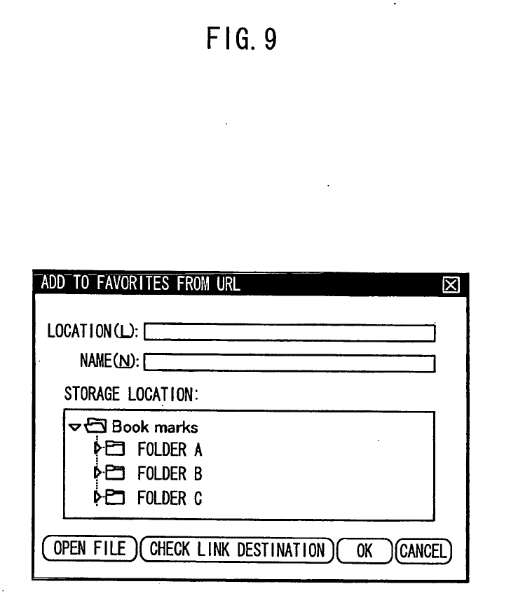

Processes and operations of the information processing apparatus 100 (FIG. 1) are described below in detail. FIGS. 7 and 8 are flowcharts showing a processing procedure of the information processing apparatus 100. The information processing apparatus 100 displays a URL input dialog (operation S101). FIG. 9 is a diagram showing an example of the URL input dialog. The URL input dialog is outputted to the output device 20 by the favorite's addition processing unit 161 in response to a URL registration request obtained from the input device 10.

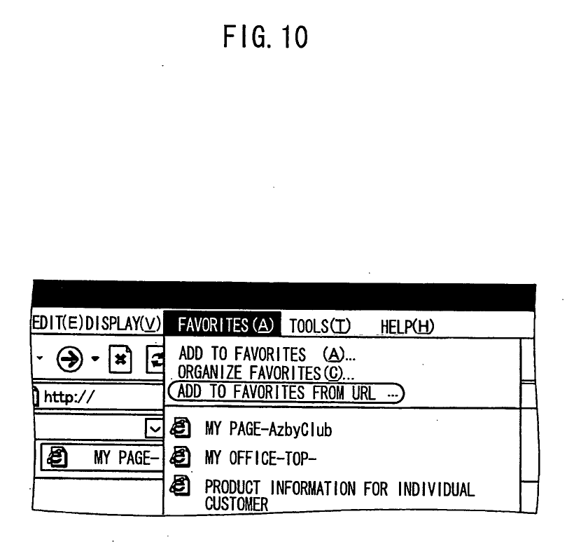

FIG. 10 is a diagram showing an example of a browser screen displayed on the output device 20. For example, when “Add to Favorites from URL” is selected on the browser screen, the favorites addition processing unit 161 displays the URL input dialog shown in FIG. 9.

Returning to the description of FIGS. 7 and 8, the favorites addition processing unit 161 determines whether or not “Open File” has been selected on a URL input dialog screen (operation S102), and if “Open File” has been selected (Yes at operation S103), the favorites addition processing unit 161 reads the registered URL file 151 (operation S104), and proceeds to operation S106.

On the other hand, if “Open File” has not been selected and the URL has been directly inputted (No at operation S103), the favorites addition processing unit 161 accepts the inputted URL (operation S105). The URL check processing unit 162 reads the URL history table 152 (operation S106), compares information of the URL to be registered in favorites with the URL history table 152 (operation S107), generates the searched information and outputs results thereof to the favorites addition processing unit 161 (operation S108).

Subsequently, the URL check processing unit 162 determines whether or not any URL to be registered in the favorites which does not exist in the URL history table 152 exists (operation S109), and if no such URL exists (No at operation S110), the URL registration process is terminated.

On the other hand, if the URL to be registered in the favorites which does not exist in the URL history table 152 exists (Yes at operation S110), the URL check processing unit 162 determines whether or not the web site corresponding to the URL exists on the Internet (operation S111).

If the web site corresponding to the URL does not exist on the Internet (No at operation S112), the URL history table is updated (operation S113), an error message is displayed on the output device 20 (operation S114), and the process proceeds to operation S101.

On the other hand, if the web site corresponding to the URL exists on the Internet (Yes at operation S112), the URL check processing unit 162 obtains the title from the web site (operation S115), and updates the URL history table 152 (operation S116).

Then, the favorites addition processing unit 161 causes the search result (for example, see FIG. 5) to be outputted to the output device 20 (operation S117), and determines whether or not “OK button” has been selected (operation S118). If “OK button” has been selected (Yes at operation S119), the favorites addition processing unit 161 registers the URL in the favorites registration table 153 (operation S120). If “NO button” has been selected (No at operation S119), the process is terminated without the registration.

In this way, since the URL check processing unit 162 determines whether or not the URL to be registered exists on the Internet, the burden on the user is reduced.

As described above, according to the disclosed information processing apparatus 100, the favorites addition processing unit 161 obtains the URL to be registered, the URL check processing unit 162 determines whether or not the obtained URL exists on the Internet, and based on the determination result by the URL check processing unit 162, the URL is registered in the favorites registration table 153. Therefore, necessity for the user to bother to refer to the web site corresponding to the URL is eliminated.

Moreover, according to the information processing apparatus 100 according to an embodiment, the favorites addition processing unit 161 does not output the web site corresponding to the URL to the output device 20 when the URL is registered, which can minimize the data communication traffic with respect to the apparatus running the web site.

Moreover, the information processing apparatus 100 according to an embodiment stores the URL history table 152 in the storage unit 150 and prevents the URL which has been previously searched from being searched again with respect to its existence or nonexistence. Therefore, the data communication traffic with respect to the apparatus running the web site can be further reduced.

Incidentally, in the respective processes described in this embodiment, all or some of the described processes which are automatically performed can be manually performed, or all or some of the described processes which are manually performed can be automatically performed by a known method. In addition, the processing procedure, the control procedure, specific names, and information including various data or parameters described above or shown in the drawings can be arbitrarily changed except for specified cases.

Moreover, the configuration of the information processing apparatus 100 shown in FIG. 1 is functionally conceptual, and is not necessarily required to be physically configured as shown in the drawings. In other words, specific forms of distribution and integration of the respective devices are not limited to those shown in the drawings, and all or some of the respective devices can be configured by functionally or physically distributing or integrating them in arbitrary units or components depending on various loads, usage statuses and the like. Furthermore, all or any of the respective processing functions or operations performed in the respective devices can be realized by a CPU and a program analyzed and executed by the above described CPU, or can be realized as wired-logic hardware.

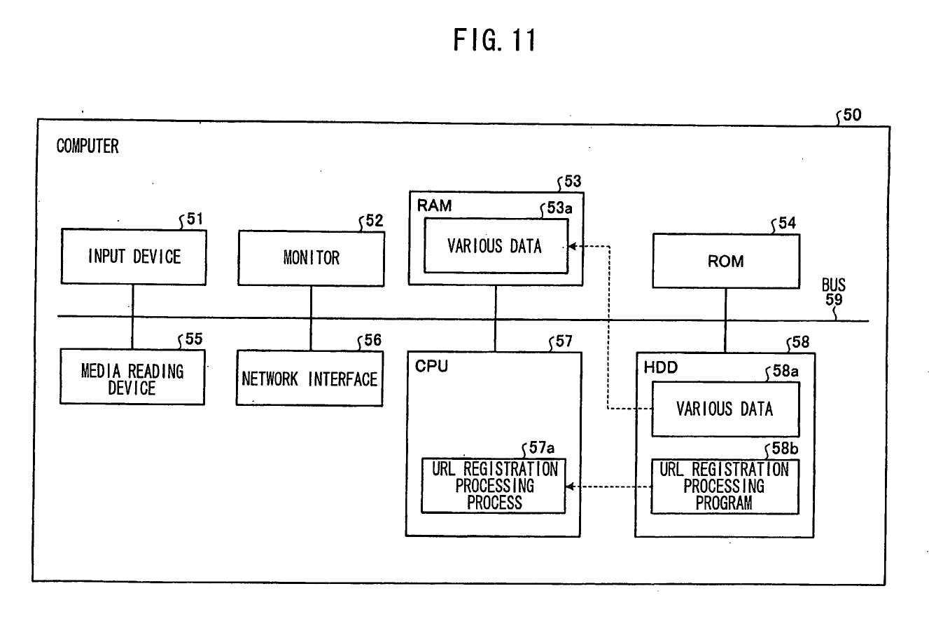

FIG. 11 is a diagram showing a hardware configuration of a computer configuring the information processing apparatus 100 shown in FIG. 1. The computer 50 is configured by connecting an input device 51 enabled to accept data input from a user, a monitor 52, a RAM (Random Access Memory) 53, a ROM (Read Only Memory) 54, a media reading device 55 enabled to read programs from a recording medium which has recorded various programs, a network interface 56 which transmits and receives data with respect to another computer via the network, a CPU (Central Processing Unit) 57 and a HDD (Hard Disk Drive) 58, via a bus 59.

In the HDD 58, a URL registration processing program 58b which fulfills functions and/or operations similar to those of the above described information processing apparatus 100 is stored. When the CPU 57 reads and executes the URL registration processing program 58b from the HDD 58, a URL registration processing process 57a which realizes the functions of functional units of the above described information processing apparatus 100 is started. This URL registration processing process 57a corresponds to the favorite's addition processing unit 161, the URL check processing unit 162 and the Web page browse processing unit 163 shown in FIG. 1.

Moreover, in the HDD 58, various data 58a corresponding to the data to be stored in the storage unit 150 of the above described information processing apparatus 100 is stored. This various data 58a stored in the HDD 58 corresponds to the registered URL file 151, the URL history table 152 and the favorite's registration table 153 shown in FIG. 1.

The CPU 57 stores the various data 58a in the HDD 58, and also reads the various data 58a from the HDD 58 to store the same in the RAM 53, and then uses various data 53a stored in the RAM 53 to execute the URL registration process.

It should be noted that, although this embodiment has shown an example of executing the URL registration process (for example, corresponding to the processes shown in FIGS. 7 and 8) with an example of a personal computer, this example is not limited thereto and can also be similarly applied to a portable terminal device such as a mobile phone, etc. In the portable terminal device, a fee may be added depending on the data communication traffic. Therefore, if the URL registration process according to the present technique is applied, the data communication traffic at the time of registering the URL can be significantly reduced, thereby minimizing the usage fee.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An information processing apparatus which registers identification information for identifying a location of an information providing site on a network, in response to a registration request from a user, comprising:
a determination unit determining whether a site corresponding to identification information obtained exists on the network; and
a registration unit registering said identification information in a storage device based on a result of the determining by said determination unit when the registration request from the user has been accepted.

2. The information processing apparatus according to claim 1, wherein multiple pieces of said identification information have been obtained, said determination unit determines whether a site corresponding to each piece of the identification information exists on the network, and
said registration unit, if the registration request from the user has been accepted, registers said identification information corresponding to the site which exists on the network in the storage device based on the determination result by said determination unit.

3. The information processing apparatus according to claim 1, further comprising:
a history information storage unit storing a history of the result by said determination unit as history information, wherein said determination unit determines whether said site exists on the network using said history information.

4. The information processing apparatus according to claim 3, wherein when said identification information has been obtained and the registration request from the user has been accepted, said determination unit determines whether said identification information is included in said history information, and
when said identification information is not included in said history information, said determination unit accesses the site corresponding to said identification information and determines whether said site exists on the network.

5. An identification information registration method for registering identification information for identifying a location of an information providing site on a network, in response to a registration request from a user, comprising:
determining whether a site corresponding to identification information obtained exists on the network; and
registering said identification information in a storage device based on a result of the determining when the registration request from the user has been accepted.

6. The identification information registration method according to claim 5, comprising:
determining whether a site corresponding to each piece of multiple pieces of identification information obtained exists on the network, and
registering, if the registration request from the user has been accepted, said identification information corresponding to the site which exists on the network in the storage device based on the determining.

7. The identification information registration method according to claim 5, further comprising:
storing a history of the result of said determining as history information in the storage device, wherein said determining uses said history information to determine whether said site exists on the network.

8. The identification information registration method according to claim 5, further comprising:
determining whether a uniform resource locator of a web site exists on a network by querying previously stored access data pertaining to the web site; and
registering information identifying a location of the web site in accordance with a result of said determining.

9. A computer-readable recording medium recording thereon an identification information registration program executed by a computer for causing the computer to execute operations including registering identification information for identifying a location of an information providing site on a network, in response to a registration request from a user, said operations comprising:
determining whether a site corresponding to identification information obtained exists on the network; and
registering said identification information in a storage device based on a result of the determining.

10. The computer-readable recording medium according to claim 9, comprising:
determining whether a site corresponding to each piece of multiple pieces of identification information obtained exists on the network when the registration request has been accepted, and
registering said identification information corresponding to the site which exists on the network in the storage device based on the determining.

11. The computer-readable recording medium according to claim 9, further causing the computer to execute:
storing a history of the result of said determining as history information in the storage device, wherein said determining uses said history information to determine whether said site exists on the network.
